(19) United States
(12) Patent Application Publication
(10) Pub. No.: US 2025/0115080 A1
(43) Pub. Date: Apr. 10, 2025

(54) PNEUMATIC VEHICLE TYRE

(71) Applicant: Continental Reifen Deutschland GmbH, Hannover (DE)

(72) Inventors: Holger Gastrich, Seelze (DE); Andrej Proksa, Bratislava (SK)

(73) Assignee: Continental Reifen Deutschland GmbH, Hannover (DE)

(21) Appl. No.: 18/728,698

(22) PCT Filed: Jan. 11, 2023
(86) PCT No.: PCT/DE2023/200008

§ 371 Date: Jul. 12, 2024

(30) Foreign Application Priority Data
Jan. 14, 2022 (DE) 10 2022 200 421.3

(51) Int. Cl. B60C 11/03; B60C 11/01

(52) U.S. Cl. CPC B60C 11/032; B60C 11/01; B60C 2011/0346

(57) ABSTRACT

A pneumatic vehicle tire with sidewalls and a tread with at least one shoulder-side profile rib delimited by a circumferential groove with a rib outer surface and a shoulder flank extending to the respective sidewall. The shoulder-side profile rib is provided with depressions, which proceed from the shoulder flank and have an opening on the rib outer surface.

The opening of the depression when viewed from above, is elongate-rectangular in the axial direction or elongate-trapezoidal in the axial direction.

### BRIEF SUMMARY

The invention relates to a pneumatic vehicle tire with sidewalls and a tread with at least one shoulder-side profile rib delimited by a circumferential groove with a rib outer surface and a shoulder flank extending to the respective sidewall, wherein the shoulder-side profile rib is provided with depressions which proceed from the shoulder flank and have an opening on the rib outer surface, wherein the opening is delimited on the inner side of the tread by a first delimiting edge lying completely within the shoulder-side profile rib, and in the circumferential direction by two second delimiting edges, and wherein the opening between the second delimiting edges in the circumferential direction has a width with a maximum value of 10.0 mm to 30.0 mm.

One tire of this type, designed as a commercial vehicle tire, is known, for example, from JP 514 411 6 B2. The commercial vehicle tire has a tread with two shoulder-side profile ribs, which are each provided with depressions which proceed from the shoulder flanks and are open toward the rib outer surface. When viewed in the cross section aligned in the axial direction, the depressions are delimited by a slightly S-shaped curved base which transitions into the rib outer surface without a bend. At the level of the rib outer surface, the depressions have a narrow shape elongate in the circumferential direction, wherein they—determined in each case at the level of the rib outer surface—have a width of up to 10 mm in the axial direction and a length of up to 25 mm in the circumferential direction. The tire should be suitable for driving on both paved and unpaved roads.

In the case of a pneumatic vehicle tire of the type mentioned above, the depressions formed on the shoulder flanks help to improve traction properties on wet, snowy, sandy, gravelly and muddy surfaces. In addition, the depressions have a cooling effect on the shoulder-side profile ribs, which reduces the risk of tire damage. The latter is particularly relevant in the summer months, when the asphalt is heated up to a correspondingly high temperature. When designing the depressions, it is particularly important to ensure that the surfaces delimiting the depressions are crack-resistant and that no stones can get trapped in the depressions.

The invention is based on the object of further improving the cooling effect of the depressions in a pneumatic vehicle tire of the type mentioned above, wherein a high crack resistance is still to be provided in the region of the depressions and the probability of stones being trapped in the latter should be low.

The stated object is achieved according to the invention in that the opening of the depression, when viewed from above, is elongate-rectangular in the axial direction or elongate-trapezoidal in the axial direction, wherein the depression has an end flank, proceeding from the first delimiting edge, and a base, wherein the end flank, when viewed from above in the cross section running perpendicular to the first delimiting edge, runs at an angle of 8° to 20° in relation to the radial direction, and wherein the base, when viewed from above in the cross section aligned perpendicularly to the first delimiting edge, consists of an inner base portion running at a constant depth, an outer base portion extending at an angle of 30° to 60° in relation to the radial direction, and a middle base portion which is outwardly convex in an arcuate manner and tangentially adjoins these base portions.

The elongate opening on the rib outer surface significantly improves the cooling effect. The specially angled or curved base portions of the base are particularly favorable for crack resistance. Due to the steep end flank, the probability of stones being trapped is extremely low.

According to a preferred embodiment, the width of the opening of the depression decreases continuously in the direction of the inner side of the tread, so that the width has its maximum value at the tread outer ends of the second delimiting edges and its minimum value at the tread inner ends of the second delimiting edges. This mainly helps to further reduce the likelihood of stones becoming trapped in the depressions.

In the latter embodiment, it is advantageous if the minimum value of the width is 40% to 60%, in particular 45% to 55%, of the maximum value of the width. This is especially beneficial for the cooling effect, while at the same time the probability of stones being trapped is low.

According to a further preferred embodiment, the opening of the depression has a maximum length, determined at the level of the rib outer surface and projected in the axial direction, of 30% to 50%, preferably of 40% to 45%, of the maximum width of the shoulder-side profile rib, determined at the level of the rib outer surface and projected in the axial direction. Adjusting the width of the opening of the depression to the width of the profile rib in such a way contributes to a further improvement of the cooling effect.

Another preferred embodiment is characterized in that the constant depth at which the inner base portion runs is 50% to 80%, in particular 55% to 75%, preferably 60% to 70%, of the profile depth. As a result, a good cooling effect of the depression is maintained as the shoulder-side profile rib becomes subject to abrasion.

Preferably, the angle at which the end flank, when viewed from above in the cross section running perpendicular to the first delimiting edge, runs in relation to the radial direction is 10° to 15°. An inclined end flank of this type also helps to reduce the likelihood of stones being trapped.

According to a further preferred embodiment, the angle at which the outer base portion, when viewed from above in the cross section aligned perpendicularly to the first delimiting edge, runs in relation to the radial direction is 45° to 55°. This design embodiment contributes to maintaining a high crack resistance in the area of the depression.

Another preferred embodiment is characterized in that, when viewed from above in the cross section aligned perpendicularly to the first delimiting edge, the outer base portion has a length, determined parallel to the rib outer surface, of 27% to 37%, in particular of 30% to 35%, of the length of the base, determined in an analogous way. This measure also contributes to maintaining a high crack resistance in the region of the depression.

According to a further preferred embodiment, when viewed from above in the cross section aligned perpendicularly to the first delimiting edge, the inner base portion has a length, determined parallel to the rib outer surface, of 27% to 37%, in particular of 30% to 35%, of the length of the base, determined in an analogous way.

According to a preferred variant of embodiment, the outer base portion, when viewed from above in the cross section aligned perpendicularly to the first delimiting edge, ends at the shoulder flank.

According to an alternative preferred variant of embodiment, the outer base portion, when viewed from above in the cross section aligned perpendicularly to the first delimiting edge, ends in front of the shoulder flank at a spacing of up to 3.0 mm, determined parallel to the rib outer surface.

In the latter preferred variant of embodiment, it is favorable if the depression at its outer end has an end-side plateau surface which proceeds from the shoulder flank, runs at a constant depth determined in the radial direction, is elongate in the circumferential direction, and has a width of 1.0 mm to 2.0 mm, determined transversely to the circumferential direction.

Another preferred embodiment is characterized in that the outer base portion ends at its end facing the shoulder flank ends at a depth, determined in the radial direction, of 90% to 100%, in particular of at least 95%, of the profile depth. The depression is therefore designed to be correspondingly deep at its outer end, which is of further advantage, especially for the cooling effect.

For the crack resistance in the region of the depression, it is further advantageous if the depression has lateral surfaces which proceed from the second delimiting edges and, when viewed from above in the cross section aligned perpendicularly to the associated second delimiting edge, run at an angle of 8° to 25°, in particular of 10° to 15°, in relation to the radial direction.

Another preferred embodiment is characterized in that the shoulder-side circumferential groove, when viewed from above, runs in a zigzag shape and is composed of groove portions which run in each case at an angle of 15° to 30°, in particular of 20° to 25°, in relation to the circumferential direction, wherein the shoulder-side circumferential groove at the mutual connecting regions of the groove portions each has a bending point with a bend inner side and a bend outer side, wherein the depressions are in each case located so as to be axially beside a bend inner side. Due to this measure, the shoulder-side profile rib has a homogenized rigidity, since the depressions are located at those points where the profile rib is embodied the widest in the axial direction.

### BRIEF DESCRIPTION OF THE SEVERAL VIEWS OF THE DRAWINGS

Further features, advantages and details of the invention will now be described in more detail with reference to the drawing, which schematically shows an exemplary embodiment of the invention. In the drawing:

FIG. 1 shows a view from above onto a circumferential portion of a tread of a commercial vehicle tire having a variant of embodiment of the invention;

FIG. 2 shows an enlarged view from above onto the detail Z₂ of FIG. 1;

FIG. 3 shows a section along the line III-III of FIG. 2;

FIG. 4 shows a section along the line IV-IV of FIG. 2; and

FIG. 5 shows an oblique view according to the viewing direction indicated by the arrow S₅ in FIG. 2.

### DETAILED DESCRIPTION

Pneumatic vehicle tires embodied according to the invention are tires for motor vehicles, in particular for multi-track motor vehicles, and preferably radial tires for commercial vehicles (medium-heavy motor trucks: 7.5 t<GVW≤18.0 t, heavy trucks: GVW>18.0 t).

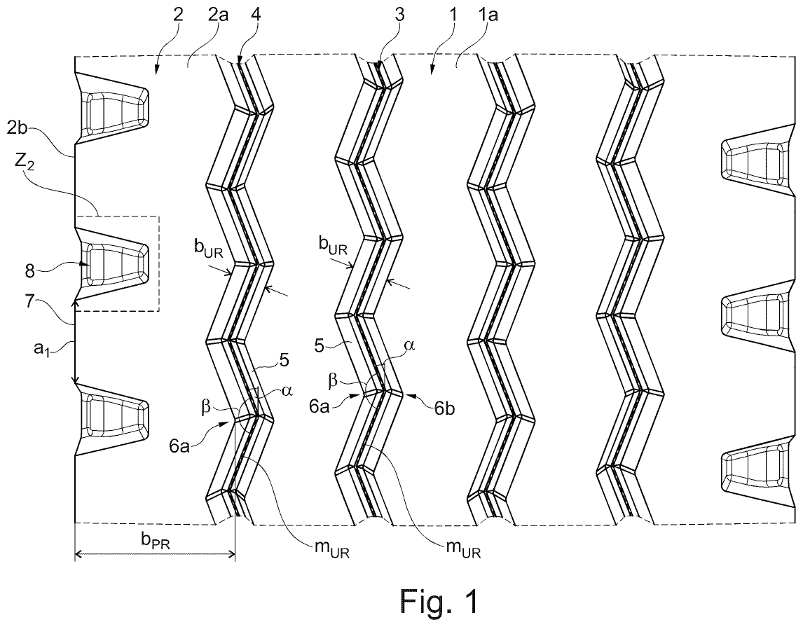

FIG. 1 shows a view from above onto a tread of a commercial vehicle tire. The tread has three middle profile ribs 1 and two shoulder-side profile ribs 2, wherein the middle profile ribs 1 are separated by two middle circumferential grooves 3, and the shoulder-side profile ribs 2 are in each case separated from the adjacent middle profile rib 1 by a shoulder-side circumferential groove 4. The profile ribs 1, 2 each have a rib outer surface 1a (profile rib 1), 2a (profile rib 2) lying in the tread periphery. The shoulder-side profile ribs 2 are further delimited by a shoulder flank 2b extending outside the ground contact patch to the respective sidewall not shown (see FIG. 5).

When viewed from above, the circumferential grooves 3, 4 extend in a regular zigzag shape, each have a groove centerline m_{UR} following the groove course when viewed from above and consist of groove portions 5, which—with reference to the groove centerline m_{UR}—are in each case at an angle α of 15° to 30°, in particular of 20° to 25°, in relation to the circumferential direction, wherein—in accordance with the zigzag shape—immediately successive groove portions 5 are inclined opposite to one another with respect to the circumferential direction. At the mutual connection region of two groove portions 5, the circumferential groove 3, 4 has in each case a bending point with a bend inner side 6a and a bend outer side 6b. The bend inner side 6a is the side by way of which the adjacent groove portions 5 conjointly enclose an angle β of less than 180° in relation to the groove centerline m_{UR}. The circumferential grooves 3, 4 are embodied at the respective envisaged profile depth in the radial direction, which is in particular 12.0 mm to 26.0 mm, and have a width b_{UR} of 10.0 mm to 25.0 mm measured perpendicularly to the groove centerline m_{UR} at the tread periphery. If circumferential grooves 3, 4 are provided with different depths, the profile depth is understood to be the depth of the respective deepest circumferential groove(s) 3, 4.

In each shoulder-side profile rib 2, the rib outer surface 2a adjoins the respective shoulder flank 2b, wherein a sharp peripheral edge 7 is formed at the mutual connection in the exemplary embodiment shown. The rib outer surface 2a therefore ends at the peripheral edge 7 on the outside of the tread. Between the rib outer surface 2a and the shoulder flank 2b, a transition radius may alternatively be provided so that the rib outer surface 2a ends at the radially outer end of the transition radius.

Each shoulder-side profile rib 2 has a maximum width b_{PR}, determined at the level of the rib outer surface 2a and projected in the axial direction, and is provided with a plurality of cuboid-like local depressions 8 distributed over the circumference of the tread, which proceed from the shoulder flank 2b and are open toward the rib outer surface 2a, so that the peripheral edge 7, or the transition radius provided instead of the latter, is interrupted in portions, wherein the depressions 8 are located axially beside the bend inner sides 6a of the respective shoulder-side circumferential groove 4. Depressions 8 which are successive in the circumferential direction have mutual spacings a₁ of 20.0 mm to 60.0 mm, preferably of 30.0 mm to 40.0 mm, which are determined as the smallest possible spacings at the level of the rib outer surface 2a.

The further design embodiment of the depressions 8 is explained below with reference to a single depression 8.

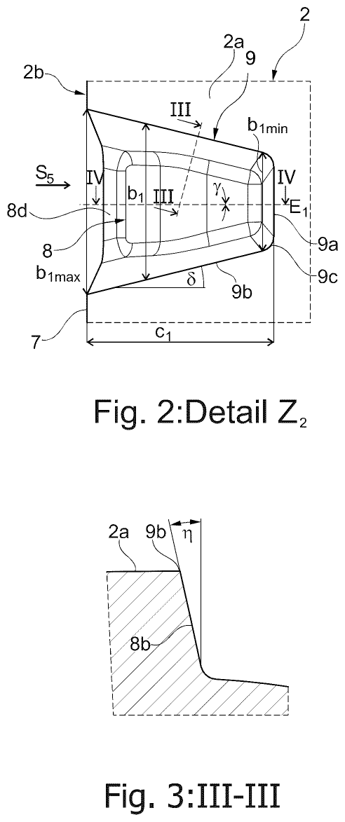

FIG. 2 shows an enlarged view from above onto a depression 8 which is formed in the left shoulder-side profile rib 2 in FIG. 1. The depression 8 has at the rib outer surface 2a an opening 9 which is elongate in the axial direction when viewed from above, and a symmetry plane E₁ aligned in the longitudinal extent of said depression 8 and running in the radial direction (coincides with the section line IV-IV). The symmetry plane E₁, when viewed from above, extends at an angle γ of +/−5°, in particular of +/−3°, particularly preferably of 0°, in relation to the axial direction, and thus in the axial direction.

The opening 9 has the shape of an isosceles trapezoid, wherein the shorter base side of the trapezoid is within the shoulder-side profile rib 2 and the longer base side of the trapezoid is on the shoulder flank 2b.

The opening 9 has on the rib outer surface 2a a delimiting edge 9a which lies completely within the profile rib 2, runs rectilinearly and forms the shorter base side of the trapezoid, and two delimiting edges 9b which run straight and to the peripheral edge 7, each forming a trapezoidal leg, wherein in the exemplary embodiment a circular-arcuate radiussed transition edge 9c runs in each case between the delimiting edges 9b and the delimiting edge 9a, said transition edge 9c adjoining the respective delimiting edge 9b without a bend, and adjoining the delimiting edge 9a without a bend. The delimiting edge 9a delimits the opening 9 on the inside of the tread and runs perpendicular to the symmetry plane E₁. The delimiting edges 9b delimit the opening 9 in the circumferential direction and, when viewed from above, run at an angle δ of 5° to 25°, in particular of 10° to 20°, particularly preferably of 12° to 18°, in relation to the axial direction, wherein the one delimiting edge 9b is inclined toward the axial direction in the opposite direction of the other delimiting edge 9b—so as to correspond to the trapezoidal shape.

The opening 9 has a width bi which is determined between the delimiting edges 9b in the circumferential direction and decreases continuously from the tread outer ends of the delimiting edges 9b to the tread inner ends of the delimiting edges 9b, so that the width b₁ has its maximum value b₁ₘₐₓ at the tread outer ends of the delimiting edges 9b, and its minimum value b₁ₘᵢₙ at the tread inner ends of the delimiting edges 9b. The maximum value b₁ₘₐₓ is 10.0 mm to 30.0 mm, in particular 15.0 mm to 25.0 mm, and the minimum value b₁ₘᵢₙ is 40% to 60%, in particular 45% to 55%, of the maximum value b₁ₘₐₓ. The opening 9 furthermore has a maximum length c₁, determined at the level of the rib outer surface 2a and projected in the axial direction, of 30% to 50%, preferably of 40% to 45%, of the maximum width b_{PR} (FIG. 1) of the shoulder-side profile rib 2.

According to FIG. 5, the depression 8 is delimited in the radial direction by a base 8c, in the direction of the inner side of the tread by an end flank 8a which proceeds from the delimiting edge 9a, and in the circumferential directions by two lateral surfaces 8b which proceed from the delimiting edges 9b.

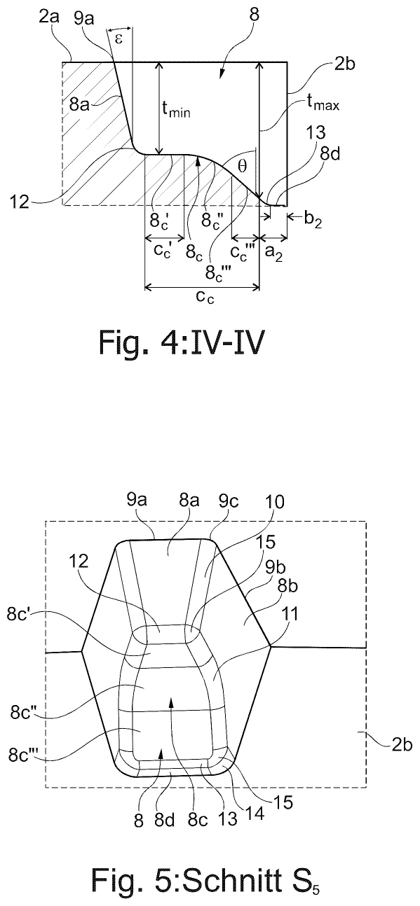

As shown in FIG. 4, the end flank 8a, when viewed from above in the cross section aligned perpendicularly to the delimiting edge 9a (cf. position of the line IV-IV in FIG. 2), runs at an angle ε of 8° to 20°, in particular of 10° to 15°, in relation to the radial direction, wherein the inclination takes place in such a manner that the radially outer end of the end flank 8a lying on the delimiting edge 9a is closer to the inner side of the tread.

According to FIG. 3, the lateral surfaces 8b, when viewed from above in the cross section aligned perpendicularly to the associated delimiting edge 9b (cf. position of the line III-III in FIG. 2), run at an angle η of 8° to 25°, in particular of 10° to 15°, in relation to the radial direction, wherein the inclination of the lateral surfaces 8b takes place in such a manner that the mutual clear spacing between the lateral surfaces 8b increases in the direction of the rib outer surface 2a.

As shown in FIG. 4 and FIG. 5 respectively, the base 8c is composed of an inner base portion 8c′, a middle base portion 8c″ and an outer base portion 8c″′, wherein the outer base portion 8c″′ is closer to the shoulder flank 2b compared to the inner base portion 8c′. The base 8c, and therefore each base portion 8c′, 8c″, 8c″′, runs straight and parallel to the rib outer surface 2a when viewed in the cross section aligned in the circumferential direction.

According to FIG. 4, the base 8c, when viewed from above in the cross section aligned perpendicularly to the delimiting edge 9a, has a length c_{c} determined parallel to the rib outer surface 2a.

The inner base portion 8c′, when viewed from above in the cross section aligned perpendicularly to the delimiting edge 9a, runs at a constant depth tₘᵢₙ, determined in the radial direction, of 50% to 80%, in particular of 55% to 75%, preferably of 60% to 70%, of the profile depth and has a length c_{c}′, determined parallel to the rib outer surface 2a, of 27% to 37%, in particular of 30% to 35%, of the length c_{c}.

The outer base portion 8c′″, when viewed in the last-mentioned cross section, runs at a constant angle θ of 30° to 60°, in particular of 45° to 55°, in relation to the radial direction, has a length c_{c}″′, determined parallel to the rib outer surface 2a, of 27% to 37%, in particular of 30% to 35%, of the length c_{c}, and ends in front of the shoulder flank 2b on the outside of the tread at a spacing a₂ of up to 3.0 mm, determined parallel to the rib outer surface 2a. Alternatively, the outer base portion 8c′″ may end at the shoulder flank 2b.

The middle base portion 8c″, when viewed in the last-mentioned cross section, runs continuously outwardly convex in an arcuate manner and furthermore, in particular, along a circular arc, wherein said middle base portion 8c″ adjoins tangentially (“bend-free”) to the inner base portion 8c′ and tangentially to the outer base portion 8c″′. “Adjoin tangentially” means that a tangent passing through the respective mutual connection and applied to one portion (base portion 8c′ and 8c′″) and a tangent passing through the same mutual connection and applied to the other portion (base portion 8c″) have concurrent slopes and therefore these tangents coincide.

The design embodiment of the base portions 8c′, 8c″, 8c′″ is mutually adapted in particular in such a manner that the outer base portion 8c″′ at its end facing the shoulder flank 2b ends at a depth tₘₐₓ, determined in the radial direction, of 90% to 100%, in particular of at least 95%, of the profile depth.

According to FIG. 5, the depression 8 in the exemplary embodiment shown has an end-side plateau surface 8d, which lies at its outer end, is substantially rectangular when viewed from above and is elongate in the circumferential direction (cf. FIG. 2), and runs at a constant depth, determined in the radial direction, and when viewed from above in the cross section aligned transversely to the circumferential direction, has a constant width b₂ (FIG. 4) of 1.0 mm up to 2.0 mm.

In the exemplary embodiment shown, two transition radii 10, two transition radii 11, a transition radius 12, a transition radius 13 and a transition radius 14 are formed between the mentioned surfaces delimiting the depression 8, said surfaces including the end flank 8a, the lateral surfaces 8b, the base 8c and the plateau surface 8d. The two transition radii 10 proceed from the mentioned, circular-arcuate radiussed transition edges 9c and run in each case between the end flank 8a and one of the lateral surfaces 8b. The transition radii 11 run between the base 8c and one of the lateral surfaces 8b, extending over all the base portions 8c′, 8c″, 8c″′. The transition radius 12 (cf. FIG. 4) runs between the end flank 8a and the inner base portion 8c′. The transition radius 13 (cf. FIG. 4) runs between the outer base portion 8c′″ and the plateau surface 8d. The transition radii 14 extend between the plateau surface 8d and the lateral surfaces 8b. The design embodiment of all transition radii 10, 11, 12, 13, 14 is such that these ensure tangential transitions between the respective surfaces delimiting the depression 8 (end flank 8a, lateral surfaces 8b, base 8c, plateau surface 8d), these transition radii 10, 11, 12, 13, 14 thus adjoining the respective surfaces without bends. Correspondingly radiussed corner regions 15 result at the mutual connection points of the transition radii 10, 11, 12, 13, 14.

The invention is not limited to the exemplary embodiment described.

The circumferential grooves 3, 4 can run straight when viewed from above. The depressions 8 can also be formed only in a shoulder-side profile rib 2. The opening 9 of the depression 8, when viewed from above, can be elongate-rectangular in the axial direction.

### LIST OF REFERENCE SIGNS

1 . . . Middle profile rib
1a . . . Rib outer surface
2 . . . Shoulder-side profile rib
2a . . . Rib outer surface
2b . . . Shoulder flank
3 . . . Middle circumferential groove
4 . . . Shoulder-side circumferential groove
5 . . . Groove portion
6a . . . Bend inner side
6b . . . Bend outer side
7 . . . Peripheral edge
8 . . . Depression
8a . . . End flank
8b . . . Lateral surface
8c . . . Base
8c′ . . . Inner base portion
8c″ . . . Middle base portion
8c′″ . . .Outer base portion
8d . . .Plateau surface
9 . . . Opening
9a, 9b . . . Delimiting edge
9c . . . Transition edge
10 . . .Transition radius
11 . . . Transition radius
12 . . . Transition radius
13 . . . Transition radius
14 . . . Transition radius
15 . . . Radiussed corner region
a₁, a₂ . . . Spacing
b_{PR} . . . Maximum width
b₁, b₂ . . . Width
b₁ₘₐₓ . . . Maximum value
b₁ₘᵢₙ . . . Minimum value
b_{UR} . . . Width
c_{c}, c_{c}′, c_{c}′″ . . . Length
c¹ . . . Maximum length
E₁ . . . Symmetry plane
m_{UR} . . . Groove centerline
S₅ . . . Arrow (viewing direction)
tₘᵢₙ, tₘₐₓ . . . Depth
Z₂ . . . Detail
α, β, γ, δ, ε, η, θ . . . Angles

1. A pneumatic vehicle tire comprising:
sidewalls and a tread with at least one shoulder-side profile rib delimited by a circumferential groove with a rib outer surface and a shoulder flank extending to the respective sidewall;
wherein the shoulder-side profile rib is provided with depressions, which proceed from the shoulder flank and have an opening on the rib outer surface:
wherein the opening is delimited on an inner side of a tread by a first delimiting edge lying completely within the shoulder-side profile rib, and in the circumferential direction by two second delimiting edges, and wherein the opening between the second delimiting edges in the circumferential direction has a width (b1) with a maximum value of 10.0 mm to 30.0 mm;
wherein the opening of the depression, when viewed from above, is elongate-rectangular in the axial direction or elongate-trapezoidal in the axial direction;
wherein the depression has an end flank, proceeding from the first delimiting edge, and a base;
wherein the end flank, when viewed from above in the cross section running perpendicular to the first delimiting edge, runs at an angle (ε) of 8° to 20° in relation to the radial direction, and wherein the base, when viewed from above in the cross section aligned perpendicularly to the first delimiting edge, consists of an inner base portion running at a constant depth (tmin), an outer base portion extending at an angle (θ) of 30° to 60° in relation to the radial direction, and a middle base portion which is outwardly convex in an arcuate manner and tangentially adjoins these base portions.

2. The tire of claim 1, wherein the width (b1) of the opening of the depression decreases continuously in the direction of the inner side of the tread, so that the width (b1) has its maximum value (b1max) at the tread outer ends of the second delimiting edges and its minimum value (b1min) at the tread inner ends of the second delimiting edges.

3. The tire of claim 1, wherein the minimum value (b1min) of the width (b1) is 40% to 60%;

4. The tire of claim 1, wherein the opening of the depression has a maximum length (c1), determined at the level of the rib outer surface and projected in the axial direction, of 30% to 50%, of the maximum width (bPR) of the shoulder-side profile rib, determined at the level of the rib outer surface and projected in the axial direction.

5. The tire of claim 1, wherein the constant depth (tmin) at which the inner base portion runs is 50% to 80%, of the profile depth.

6. The tire of claim 1, wherein, when viewed from above in the cross section running perpendicular to the first delimiting edge, the angle (ε) at which the end flank runs in relation to the radial direction is 10° to 15°.

7. The tire of claim 1, wherein, when viewed from above in the cross section aligned perpendicularly to the first delimiting edge, the angle (θ) at which the outer base portion runs in relation to the radial direction is 45° to 55°.

8. The tire of claim 1, wherein, when viewed from above in the cross section aligned perpendicularly to the first delimiting edge, the outer base portion has a length, determined parallel to the rib outer surface, of 27% to 37%, in particular of 30% to 35%, of the length (cc) of the base, determined in an analogous way.

9. The tire of claim 1, wherein, when viewed from above in the cross section aligned perpendicularly to the first delimiting edge, the inner base portion has a length, determined parallel to the rib outer surface, of 27% to 37%, in particular of 30% to 35%, of the length (cc) of the base, determined in an analogous way.

10. The tire of claim 1, wherein the outer base portion, when viewed from above in the cross section aligned perpendicularly to the first delimiting edge, ends at the shoulder flank.

11. The tire of claim 1, wherein the outer base portion, when viewed from above in the cross section aligned perpendicularly to the first delimiting edge, ends in front of the shoulder flank at a spacing (a2) of up to 3.0 mm, determined parallel to the rib outer surface.

12. The tire of claim 1, wherein the depression at its outer end has an end-side plateau surface which proceeds from the shoulder flank, runs at a constant depth determined in the radial direction, is elongate in the circumferential direction, and has a width (b2) of 1.0 mm to 2.0 mm, determined transversely to the circumferential direction.

13. The tire of claim 1, wherein the outer base portion at its end facing the shoulder flank ends at a depth (tmax), determined in the radial direction, of 90% to 100%, of the profile depth.

14. The tire of claim 1, wherein the depression has lateral surfaces which proceed from the second delimiting edges and, when viewed from above in the cross section aligned perpendicularly to the associated second delimiting edge, run at an angle (η) of 8° to 25°, in particular of 10° to 15°, in relation to the radial direction.

15. The tire of claim 1, wherein the shoulder-side circumferential groove, when viewed from above, runs in a zigzag shape and is composed of groove portions which run in each case at an angle (α) of 15° to 30°, in particular of 20° to 25°, in relation to the circumferential direction, wherein the shoulder-side circumferential groove at the groove portions has in each case a bending point with a bend inner side and a bend outer side, wherein the depressions are in each case located so as to be axially beside a bend inner side.

16. A pneumatic vehicle tire comprising:
sidewalls and a tread with at least one shoulder-side profile rib delimited by a circumferential groove with a rib outer surface and a shoulder flank extending to the respective sidewall;
wherein the shoulder-side profile rib is provided with depressions, which proceed from the shoulder flank and have an opening on the rib outer surface:
wherein the opening is delimited on an inner side of a tread by a first delimiting edge lying completely within the shoulder-side profile rib, and in the circumferential direction by two second delimiting edges, and wherein the opening between the second delimiting edges in the circumferential direction has a width(b1) with a maximum value of 10.0 mm to 30.0 mm;
wherein the opening of the depression, when viewed from above, is elongate-rectangular in the axial direction or elongate-trapezoidal in the axial direction;
wherein the depression has an end flank, proceeding from the first delimiting edge, and a base;
wherein the end flank, when viewed from above in the cross section running perpendicular to the first delimiting edge, runs at an angle (ε) of 8° to 20° in relation to the radial direction, and wherein the base, when viewed from above in the cross section aligned perpendicularly to the first delimiting edge, consists of an inner base portion running at a constant depth (tmin), an outer base portion extending at an angle (θ) of 30° to 60° in relation to the radial direction, and a middle base portion which is outwardly convex in an arcuate manner and tangentially adjoins these base portions;
wherein the width (b1) of the opening of the depression decreases continuously in the direction of the inner side of the tread, so that the width (b1) has its maximum value (b1max) at the tread outer ends of the second delimiting edges and its minimum value (b1min) at the tread inner ends of the second delimiting edges;
wherein the minimum value (b1min) of the width (b1) is 40% to 60%; and
the circumferential groove, when viewed from above, runs in a zigzag shape and is composed of groove portions which run in each case at an angle (α) of 15° to 30°, in particular of 20° to 25°, in relation to the circumferential direction, wherein the shoulder-side circumferential groove at the groove portions has in each case a bending point with a bend inner side and a bend outer side, wherein the depressions are in each case located so as to be axially beside a bend inner side.
